(19) United States
(12) Patent Application Publication
(10) Pub. No.: US 2003/0009657 A1
(43) Pub. Date: Jan. 9, 2003

(54) Method and system for booting of a target device in a network management system

(75) Inventors: Steven M. French, Austin, TX (US); Lorin E. Ullmann, Austin, TX (US)

Correspondence Address: Frank C. Nicholas, CARDINAL LAW GROUP, Suite 2000, 1603 Orrington Avenue, Evanston, IL, 60201, US

(73) Assignee: IBM CORPORATION

(21) Appl. No.: 09/895,645

(22) Filed: Jun. 29, 2001

(51) Int. Cl. G06F 15/177

(52) U.S. Cl. 713/2

(57) ABSTRACT

A method of booting one of a plurality of target devices in a network management framework is provided. The network management framework is scanned to identify the target device. A communication value describing communication between the target device and at least one distributor is determined. The communication value is compared to a predetermined value. The distributor is assigned to the target device if the communication value is less than the predetermined value. At least one boot file is distributed to the target device using the distributor. Programs and systems of using the present invention are also provided.

### BACKGROUND OF THE INVENTION

1. Field of the Invention

The present invention relates to target devices (clients) that are bootable over a network and, in particular, clients attempting to boot in a large scale network environment with several subnets. More specifically, the present invention relates to a method for creating a physical topology for booting a target device in a network management system with topological views.

2. Description of the Related Art

Some current computing devices include support for pre-boot extensions to download an operating system (OS) from a network to which they are attached. Such target computing devices (clients) include computer motherboards, network adapters and boot diskettes. Many service providers have expressed the need to distribute software and services, such as OS software to millions of clients. Because current boot distribution protocols may require generation and/or loading of large size images, current distribution of OS software to such a large number of target devices may be difficult.

Distribution of OS software currently may rely on extensions to the bootstrap protocol (BOOTP) and to the dynamic host configuration protocol (DHCP). Such extensions are often termed the preboot execution environment (PXE) and require a DHCP/PXE server and a boot image negotiation layer (BINL) server. Alternatively, these devices may use a feature such as the Remote Program Load (RPL) feature to gain access to the network and request an operating system and other applications. The RPL feature enables the client to request a bootstrap from another device with a disk drive (the loading device) within the network. The RPL feature also allows the loading device to send the bootstrap to the client. This loading device may be, for example, a server or another suitable loading device.

Occasionally a number of clients may attempt to boot from the network (e.g., from a server or from a loading device) at the same time. As the area over which a client attempts to boot becomes larger or as the number of clients attempting to boot over the network increases, current OS distribution and management software may not operate as well. Moreover, the types of protocols used to load images from a server or loading device to a client (e.g., PXE, BINL) may not operate as well over a single subnet because the size of the images being loaded may be incompatible with distribution over a large scale network management system servicing several subnets and even more target devices.

A boot process on a client (or any computing device) is defined as a sequence of program instructions that begins automatically when the client is powered-on or reset and completes when an end-user software environment is operational on the client. The initial instructions that are executed in a boot process are fixed in the nonvolatile read-only memory (“ROM”) of the hardware of the client so that they are always available to the client, even if it was previously shut off. As the boot process progresses, program instructions are located on a source outside of the client's ROM and copied, or loaded, into the client's volatile memory, also referred to as dynamic or random access memory (“RAM”). These instructions in RAM, referred to as software, are lost whenever the client is shut off or reset and therefore must be restored from an outside source during the boot process.

Once this software has been loaded into RAM, client execution is transferred from ROM memory to this software in RAM. This software continues the boot process by iteratively locating and loading additional software into the client's RAM as required until the end-user software environment is complete and operational. Typically, this end-user software environment contains an operating system (“OS”) that does the general operation of the hardware of the client. This end-user software environment may also contain additional system programs to operate specialty hardware on the client and application programs that perform the end-user operations on the client as defined by the enterprise that owns the client.

Some clients are configured with ROM that contains instructions that direct the boot process to obtain software through the client's network interface. This is distinguished from the instructions contained in the ROM of “stand-alone” clients that direct the boot process to obtain the software to establish the end-user software environment only from nonvolatile media repositories contained in devices that are directly attached to the client, such as diskettes, hard disks, and CD-ROMs. A remote boot process allows end-user software environments to be created, located and maintained in a repository on a centrally located boot server. This represents a significant savings of administrative effort when compared with having to perform the same activities at each separate client location.

The instructions that direct the boot process to the network interface may be included in the client's Basic Input-Output System (“BIOS”) ROM that contains the initial instructions to be executed after the client is started or reset. The instructions that direct the boot process in the network interface may also be contained in a separate, or “option” ROM attached to the network interface. The client's BIOS ROM can be configured to transfer client execution to the option ROM after the initial boot instructions in the BIOS ROM have completed. This network interface and its option ROM may be integrated into the client's main system board (“motherboard”) or placed on a separate hardware communications adapter that is connected to the client's motherboard. Another alternative remote boot configuration is to have the BIOS ROM load and transfer execution to software in RAM that emulates the instructions of a remote boot option ROM. Such remote boot emulation software can be obtained from media of a local device, such as a diskette, and permits clients to be remote booted even when their network interface hardware cannot contain an option ROM for that purpose.

Once the remote boot instructions in the BIOS ROM, option ROM, or remote boot emulation software begin to execute, they must initialize the network interface hardware so that it can send and receive signals on the network to which it is attached. This is accomplished through a series of well-known directives to that hardware. Then, the remote boot instructions must initiate and support network protocols that permit the client to announce itself to potential boot servers on the network as a client that requires a remote boot. These network protocols must also permit the client and a boot server to determine each other's network addresses so that they can direct network communications to each other. Finally, these network protocols must assure the accurate delivery of software and other information through the network between the boot server and the client.

Two sets of network protocols have become widely used for remote booting of clients on networks today. One set is called Remote Program Load or Remote Initial Program Load (“RPL” or “RIPL”). This older set of network protocols is associated with Local Area Networks (“LANs”) and is primarily used when the boot servers and the remote boot clients are attached to the same LAN. Generally, this requires that the boot servers and the remote boot clients be physically located close to each other.

A RPL client initiates the network boot process by transmitting a special broadcast frame on the LAN that indicates the unique media access control (“MAC”) identifier of the client's network interface hardware as its source and indicates that the client requires a RPL boot. As a broadcast, this special frame contains a unique, well-known destination MAC identifier that indicates that any other computing device (“host”) attached to the LAN can receive the frame. This includes any hosts that are boot servers. This broadcast frame with its well-known destination MAC identifier frees the remote boot client from the “chicken and egg” problem of having to initially know the destination MAC identifier of a particular boot server to get the remote boot process started.

A boot server responds to the receipt of this broadcast frame by looking up the remote boot client's MAC identifier as a key to a record that describes the required software for the client. This record is contained in a file that lists the records of all potential remote boot clients that the boot server may service. This record indicates the name of a file on a loading device (for instance a hard disk) attached to the boot server that contains an initial network bootstrap program (an “initial NBP”) that is to operate on the client. The RPL map file record also contains other configuration data about the client to aid in remote booting the client. The file containing the initial NBP is loaded from the loading device and transmitted on the LAN to the client as a frame or series of frames that indicate the client's MAC address as the destination. The RPL process re-directs the loaded initial NBP file to the boot server's network interface for transmission to the client instead of writing it to the boot server's own RAM.

Once it is transferred to the client, this initial NBP becomes the first software loaded into the client's RAM. RPL also provides a means for running this initial NBP on the client. This initial NBP initializes and restarts the client's network interface. It also retains the MAC identifier of the boot server as a destination for possible later requests. The initial NBP may be a complete end-user software environment, or a program that requests other files from the boot server in order to assemble an end-user software environment on the client.

The other, newer set of network protocols are built upon the underlying Internet Protocol (IP) that forms the basis for the Internet and other Telecommunications Control Protocol/Internet Protocol (“TCP/IP”) wide area networks (“WANs”). As the name “wide area network” implies, this set of protocols permits boot servers and remote boot clients to be physically located far from each other.

An early protocol used for remote boot in IP networks is the “Bootstrap Protocol” (“BOOTP”). BOOTP generally requires that the boot server and the remote boot clients be located on the same IP address sub-network, and as such gives little additional capability over RPL. BOOTP also requires that each remote boot client be pre-listed in a table on the boot server and assigned a fixed IP address in order to permit it to be booted. The client initiates the BOOTP protocol by broadcasting a BOOTP Request packet that indicates the MAC identifier of the client as the source and indicates an IP broadcast address as the destination. Again, this solves the “chicken and egg” problem in a manner similar to RPL so that the client does not initially need to know the address of a boot server, except that the broadcast address used is an IP address, not a MAC identifier.

In order to execute the boot process using any one of the above-described existing protocols or any suitable boot protocol, it would be desirable to provide a method of booting one or more target devices that provides a “gateway” or “repeater” to distribute OS software over slow links. It would further be desirable to provide a method of booting one or more target devices that manages the movement of large files over a plurality of subnets and target devices. It would further be desirable to provide a method of booting one or more target devices that partitions the workload or workloads of one more boot server devices that manage booting over the network management system.

### SUMMARY OF THE INVENTION

One aspect of the present invention provides a method of booting one of a plurality of target devices in a network management framework. The network management framework is scanned to identify the target device. A communication value describing communication between the target device and at least one distributor is determined and compared to a predetermined value. The distributor is assigned to the target device if the communication value is less than the predetermined value. At least one boot file is distributed to the target device using the distributor.

The communication value may be a distance value of a distance between the target device and the distributor, or a boot time value of a time to transfer files between the target device and the distributor.

The method may also comprise assigning a distributor function to the distributor based on the communication value, wherein the function is selected from the group consisting of a distribution engine, a large file distribution component, and a distribution gateway. The method may also comprise assigning a distributor scope to the distributor based on the communication value, wherein the scope is selected from the group consisting of a pre-boot resource, a boot resource, a PXE resource, a BINL resource, a DHCP resource and a TFTP resource.

The distributor may be selected from a distribution engine, a large file distribution component, and a distribution gateway. The boot file may be sent from the distribution engine to the target device, between the large file distribution component and the target device or may be forwarded from the distribution gateway to the target device. The boot file may also be received from the distribution engine at the distribution gateway or requested at the target device. The boot file may be selected from the group consisting of a pre-boot packet request, a bootstrap program, a configuration file, a boot parameters file, and an operating system file.

The method may also include creating a distribution topology, wherein the distribution topology describes at least one distributor location and a target device location. The boot file may be distributed to the target device from the distributor using the distribution topology and the distribution topology may be stored.

Another aspect of the present invention provides computer program product in a computer usable medium for booting one of a plurality of target devices in a network management framework. The program may comprise means for scanning the network management framework to identify at least one target device. The program may also comprise means for determining a communication value, the communication value describing communication between the target device and at least one distributor. The program may also comprise means for comparing the communication value to a predetermined value. The program may also comprise means for assigning the distributor to the target device if the communication value is less than the predetermined value and means for distributing at least one boot file to the target device using the distributor.

The program may also comprise means for determining the communication value from a distance between the target device and the distributor. The program may also comprise means for measuring a boot time to transfer files between the target device and the distributor to determine the communication value. The program may also comprise means for assigning a distributor function to the distributor based on the communication value, wherein the distributor function is selected from the group consisting of a distribution engine, a large file distribution component, and a distribution gateway. The program may also comprise means for assigning a distributor scope to the distributor based on the communication value, wherein the scope is selected from the group consisting of a pre-boot resource, a boot resource, a PXE resource, a BINL resource, a DHCP resource and a TFTP resource.

The distributor is selected from the group consisting of a distribution engine, a large file distribution component, and a distribution gateway. The program may also comprise means for sending the boot file from the distribution engine to the target device. The program may also comprise means for sending the boot file between the large file distribution component and the target device. The program may also comprise means for forwarding the boot file from the distribution gateway to the target device. The program may also comprise means for receiving the boot file from the distribution engine at the distribution gateway. The program may also comprise means for requesting the boot file at the target device. The boot file may be selected from the group consisting of a pre-boot packet request, a bootstrap program, a configuration file, a boot parameters file, and an operating system file.

The program may also comprise means for creating a distribution topology, wherein the distribution topology describes at least one distributor location and a target device location. The program may also comprise means for distributing the boot file to the target device from the distributor using the distribution topology. The program may also comprise means for storing the distribution topology.

Another aspect of the present invention provides a system for booting one of a plurality of target devices in a network management framework. The system may comprise means for scanning the network management framework to identify at least one target device. The system may also comprise means for determining a communication value, the communication value describing communication between the target device and at least one distributor. The system may also comprise means for comparing the communication value to a predetermined value. The system may also comprise means for assigning the distributor to the target device if the communication value is less than the predetermined value and means for distributing at least one boot file to the target device using the distributor.

The system may also comprise means for determining the communication value from a distance between the target device and the distributor. The system may also comprise means for measuring a boot time to transfer files between the target device and the distributor to determine the communication value. The system may also comprise means for assigning a distributor function to the distributor based on the communication value, wherein the distributor function is selected from the group consisting of a distribution engine, a large file distribution component, and a distribution gateway. The system may also comprise means for assigning a distributor scope to the distributor based on the communication value, wherein the scope is selected from the group consisting of a pre-boot resource, a boot resource, a PXE resource, a BINL resource, a DHCP resource and a TFTP resource.

The distributor is selected from the group consisting of a distribution engine, a large file distribution component, and a distribution gateway. The system may also comprise means for sending the boot file from the distribution engine to the target device. The system may also comprise means for sending the boot file between the large file distribution component and the target device. The system may also comprise means for forwarding the boot file from the distribution gateway to the target device. The system may also comprise means for receiving the boot file from the distribution engine at the distribution gateway. The system may also comprise means for requesting the boot file at the target device. The boot file may be selected from the group consisting of a pre-boot packet request, a bootstrap program, a configuration file, a boot parameters file, and an operating system file.

The system may also comprise means for creating a distribution topology, wherein the distribution topology describes at least one distributor location and a target device location. The system may also comprise means for distributing the boot file to the target device from the distributor using the distribution topology. The system may also comprise means for storing the distribution topology.

The foregoing, and other, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims in equivalence thereof.

### BRIEF DESCRIPTION OF THE DRAWINGS

FIG. 1 is a schematic diagram of one embodiment of a large distributed computing enterprise environment in accordance with the present invention;

FIG. 2 is a block diagram of one embodiment of a system management framework in accordance with the present invention;

FIG. 3 is a block diagram of one embodiment of the elements that comprise the low cost framework (LCF) client component of the system management framework of FIG. 2;

FIG. 4 is a schematic diagram of one embodiment of the components within the system management framework of FIG. 2;

FIG. 5 is a schematic diagram of another embodiment of the components within the system management framework of FIG. 2, including two gateways supporting two endpoints;

FIG. 6 is a block diagram showing components within the system management framework of FIG. 2 that provide resource leasing management functionality in accordance with the present invention;

FIG. 7 is a block diagram showing one embodiment of the IPOP service of FIG. 6;

FIG. 8 is a block diagram of one embodiment of a set of routers that undergo a scoping process in accordance with the present invention;

FIG. 9 is a block diagram showing one embodiment of components that may be used to implement adaptive discover and adaptive polling in accordance with the present invention;

FIG. 10 is a block diagram showing one embodiment of an architecture for supporting the display of topology data within the network management system of FIG. 2; and

FIG. 11 is a flow diagram of one embodiment of a method of booting a target device in accordance with the present invention.

### DETAILED DESCRIPTION OF THE PRESENTLY PREFERRED EMBODIMENTS

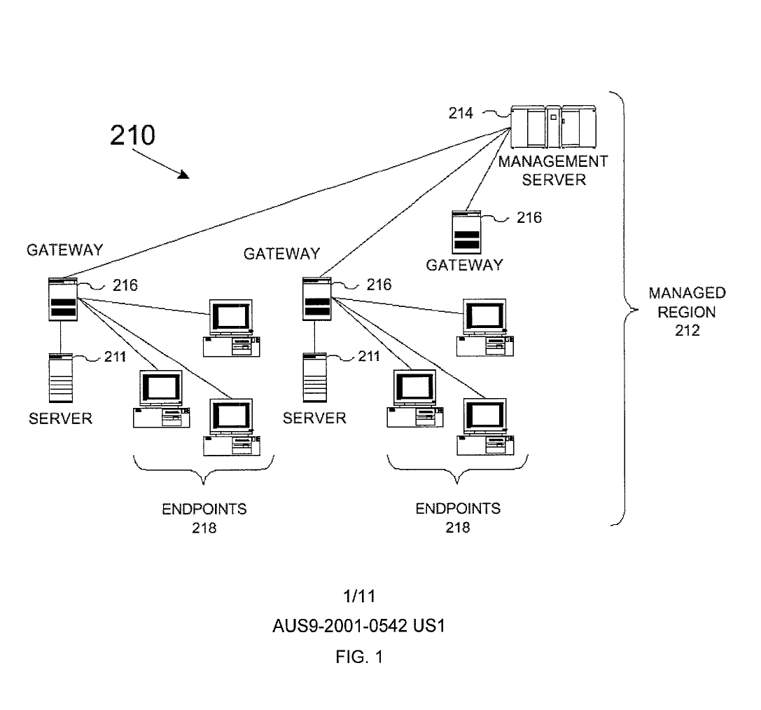

FIG. 1 shows a schematic diagram of one embodiment of a large distributed computing enterprise environment in accordance with the present invention at 210. Environment 210 may comprise thousands of “nodes”. The nodes will typically be geographically dispersed and the overall environment is “managed” in a distributed manner. Preferably, the managed environment is logically broken down into a series of loosely connected managed regions (MRs) 212, each with its own management server 214 for managing local resources with the managed region. The network typically will include other servers 211 for carrying out other distributed network functions. These include name servers, security servers, file servers, thread servers, time servers and the like. Multiple servers 214 coordinate activities across the enterprise and permit remote management and operation. Each server 214 serves a number of gateway machines 216, each of which in turn support a plurality of endpoints/terminal nodes 218. The server 214 coordinates all activity within the managed region using a terminal node manager at server 214.

In one embodiment of the invention, server 214 may be or may include, for example, an OS distribution server (“boot server”) that manages the booting of one or more endpoints (clients) and/or the distribution of OS software to one or more clients. Alternatively, server 214 may include an OS distribution engine or program, which manages the booting of one or more target endpoints. Server 214 may further include a large file distribution component (LFD) to be used in distribution of large files, such as, for example, PXE or BINL images to a given endpoint. Server 214 may provide data, such as boot files, operating system images and applications to system 210 and/or to other components in communication with system 210 as described below. Alternatively, one or more of the other servers 211 may also serve as a boot server and/or may include one or more OS distribution resources such as OS distribution engines, LFD components, etc.

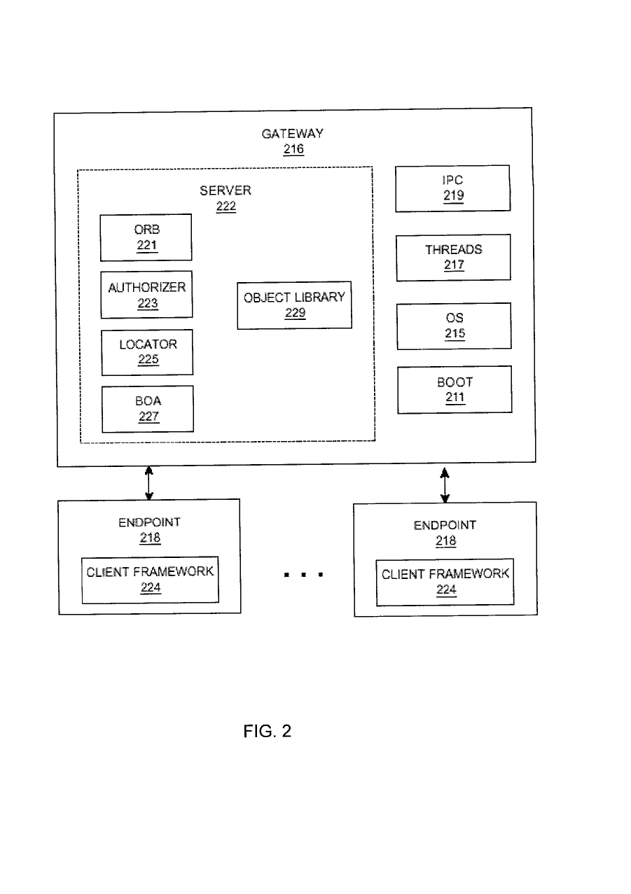

With reference now to FIG. 2, each gateway machine 216 runs a server component 222 of a system management framework. The server component 222 is a multi-threaded runtime process that comprises several components: an object request broker (ORB) 221, an authorization service 223, object location service 225 and basic object adapter (BOA) 227. Server component 222 also includes an object library 229. In one embodiment of the invention, server component 222 may also be capable of serving as a boot server or may include an OS distribution engine. Alternatively, boot component 211 may be in communication with server component 222 and able to provide boot services over the system management framework. Preferably, ORB 221 runs continuously, separate from the operating system, and it communicates with both server and client processes through separate stubs and skeletons via an interprocess communication (IPC) facility 219. In particular, a secure remote procedure call (RPC) is used to invoke operations on remote objects. Gateway machine 216 also includes operating system 215 and thread mechanism 217.

In some embodiments of the invention, gateway machine 216 may serve as an OS distribution gateway for distribution and/or management of OS resources including OS distribution engine, LFD component, and OS software as described above.

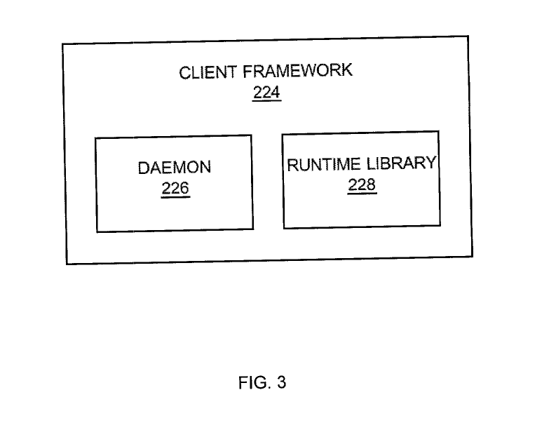

As seen in FIG. 3, the system management framework, also termed distributed kernel services (DKS), includes a client component/framework 224 supported on each of the endpoint machines 218. The client component 224 is a low cost, low maintenance application suite that is preferably “dataless” in the sense that system management data is not cached or stored there in a persistent manner. Implementation of the management framework in this “client-server” manner has significant advantages over the prior art, and it facilitates the connectivity of personal computers into the managed environment. It should be noted, however, that an endpoint may also have an ORB for remote object-oriented operations within the distributed environment, as explained in more detail further below.

In one embodiment of the invention, one or more of endpoint machines 218 may include features and/or programs that enable the devices to download OS information from a loading device, such as an OS distribution server or a device with an OS distribution engine. For example, the endpoint machine may include an RPLBOOT.COM program, which marks the fixed disk in the target device as non-bootable so that the RPL feature can take control when the target device is started. The target device may also include, for example, a program that enables it to broadcast a load request.

Using an object-oriented approach, the system management framework facilitates execution of system management tasks required to manage the resources in the managed region. Such tasks are quite varied and include, without limitation, OS file and data distribution, network usage monitoring, user management, printer or other resource configuration management, and the like. In a preferred implementation, the object-oriented framework includes a Java runtime environment for well-known advantages, such as platform independence and standardized interfaces. Both gateways and endpoints operate portions of the system management tasks through cooperation between the client and server portions of the distributed kernel services.

In a large enterprise, such as the system that is illustrated in FIG. 1, there may be one server per managed region with some number of gateways. For a workgroup-size installation, e.g., a local area network, a single server-class machine may be used as both a server and a gateway. References herein to a distinct server and one or more gateway(s) should thus not be taken by way of limitation as these elements may be combined into a single platform. For intermediate size installations, the managed region grows breadth-wise, with additional gateways then being used to balance the load of the endpoints.

The server may serve as the top-level authority over all gateway and endpoints. The server maintains an endpoint list, which keeps track of every endpoint in a managed region. This list preferably contains all information necessary to uniquely identify and manage endpoints including, without limitation, such information as name, location, default OS and machine type. The server also maintains the mapping between endpoints and gateways, and this mapping is preferably dynamic.

As noted above, there are one or more gateways per managed region. In some embodiments of the invention, a gateway is a fully managed node that has been configured to operate as a gateway. In certain circumstances, though, a gateway may be regarded as an endpoint. A gateway with a network interface card (NIC), may also always serve as an endpoint. A gateway usually uses itself as the first seed during a discovery process. Initially, a gateway does not have any information about endpoints. As endpoints login, the gateway builds an endpoint list for its endpoints. The gateway's duties may include, without limitation: listening for endpoint login requests, listening for endpoint update requests, and acting as a gateway for method invocations on endpoints.

As also discussed above, the endpoint 218 may be a machine running the system management framework client component 224, which is referred to herein as a management agent. The management agent has two main parts as illustrated in FIG. 3: daemon 226 and application runtime library 228. Daemon 226 is responsible for endpoint login and for spawning application endpoint executables. Once an executable is spawned, daemon 226 has no further interaction with it. Each executable is linked with application runtime library 228, which handles all further communication with the gateway.

Each endpoint is also a computing device. In one preferred embodiment of the invention, most of the endpoints are personal computers, e.g., desktop machines or laptops. In this architecture, the endpoints need not be high powered or complex machines or workstations. An endpoint computer preferably includes a Web browser such as Netscape Navigator or Microsoft Internet Explorer. An endpoint computer thus may be connected to a gateway via the Internet, an intranet, or some other computer network.

Preferably, the client-class framework running on each endpoint is a low-maintenance, low-cost framework that is ready to do management tasks but consumes few machine resources because it is normally in an idle state. Each endpoint may be “dataless” in the sense that system management data is not stored therein before or after a particular system management task is implemented or carried out.

In one embodiment of the invention, each endpoint 218 may include features and/or programs that enable the devices to download OS information from a desired location within system management framework.

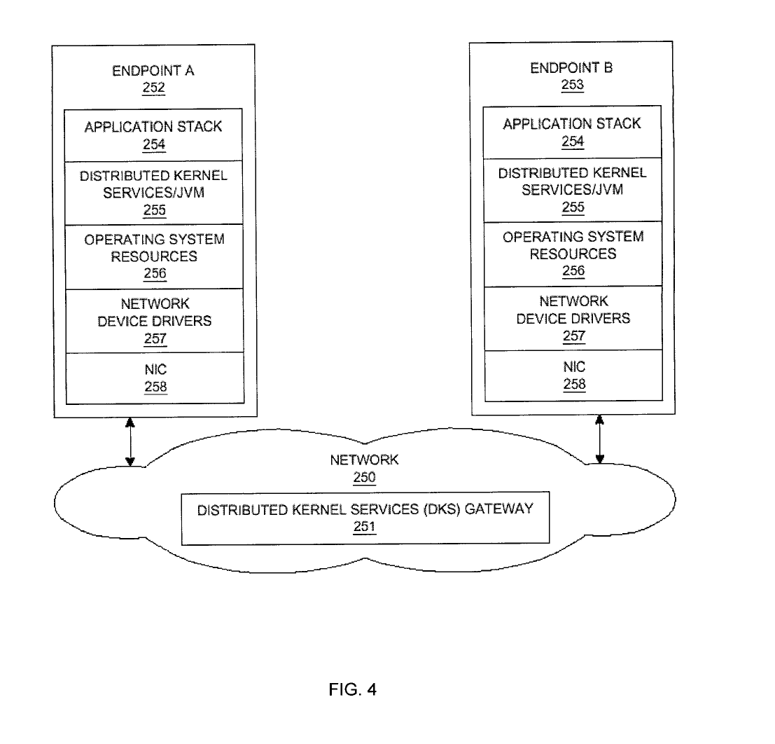

With reference now to FIG. 4, a diagram depicts the logical relationships between components within a system management framework that includes two endpoints and a gateway. FIG. 4 shows more detail of the relationship between components at an endpoint. Network 250 includes gateway 251 and endpoints 252 and 253, which contain similar components, as indicated by the similar reference numerals used in the figure. An endpoint may support a set of applications 254 that use services provided by the distributed kernel services 255, which may rely upon a set of platform-specific operating system resources 256. In one embodiment of the invention, endpoints 252, 253 include OS resources 256 such as, but not limited to, TCP/IP-type resources, SNMP-type resources, and other types of resources. For example, a subset of TCP/IP-type resources may be a line printer (LPR) resource that allows an endpoint to receive print jobs from other endpoints. These OS resources 256 may be received or requested at endpoints 252, 253 in accordance with the present invention. OS resources that may be made available to endpoints 252, 253 may further include one or more OS distribution engines and/or one or more large file distribution (LFD) components. In some embodiments of the invention, gateway 251 may serve as an OS distribution gateway for one or more endpoints 252, 253.

In some embodiments of the invention, OS resources may be used to coordinate and provide control of various components within a given endpoint. The OS may be a commercially available operating system, such as, for example, Linux™, OS/2 Warp 4, or Windows 2000™. An object oriented programming system may be in communication with the OS and may run in conjunction with the OS. For example, the object-oriented programming system may provide calls to or from the OS from programs or applications executing on a given endpoint. These programs or applications may be specific to the object-oriented programming system or may be programs or applications run by other programming systems in communication with gateway 251, network 250 or management framework 210. In one embodiment of the invention, the object-oriented programming system may be Java™, a trademark of Sun Microsystems, Inc.

Instructions for the OS, the object-oriented operating system, and applications or programs may be located on storage devices such as, for example, a disk drive of a given endpoint 218. Alternatively, such OS resources may be stored anywhere within framework 210 or transferred to endpoint 218 in accordance with the present invention from any suitable component of framework 210.

Applications 254 may also provide self-defined sets of resources that are accessible to other endpoints. Network device drivers 257 send and receive data through NIC hardware 258 to support communication at the endpoint.

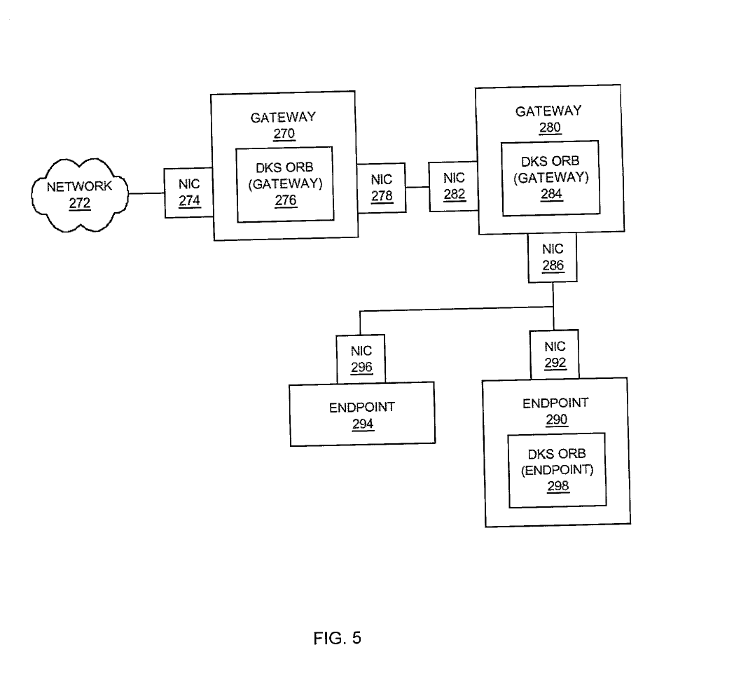

With reference now to FIG. 5, a diagram depicts the logical relationships between components within a system management framework that includes two gateways supporting two endpoints. Gateway 270 communicates with network 272 through NIC 274. Gateway 270 contains ORB 276 that may provide a variety of services, as is explained in more detail further below. In this particular example, FIG. 5 shows that a gateway does not necessarily connect with individual endpoints.

Gateway 270 communicates through NIC 278 and network 279 with gateway 280 and its NIC 282. Gateway 280 contains ORB 284 for supporting a set of services. Gateway 280 communicates through NIC 286 to endpoint 290 through its NIC 292 and to endpoint 294 through its NIC 296. Endpoint 290 contains ORB 298 while endpoint 294 does not contain an ORB. In this particular example, FIG. 5 also shows that an endpoint does not necessarily contain an ORB. Hence, any use of endpoint 294 as a resource is performed solely through management processes at gateway 280.

FIG. 5 also depicts the importance of gateways in determining routes/data paths within a highly distributed system for addressing resources within the system and for performing the actual routing of requests for resources. The importance of representing NICs as objects for an object-oriented routing system is described in more detail further below.

As noted previously, the present invention is directed to a methodology for managing a distributed computing environment. A resource is a portion of a computer system's physical units, a portion of a computer system's logical units, or a portion of the computer system's functionality that is identifiable or addressable in some manner to other physical or logical units within the system.

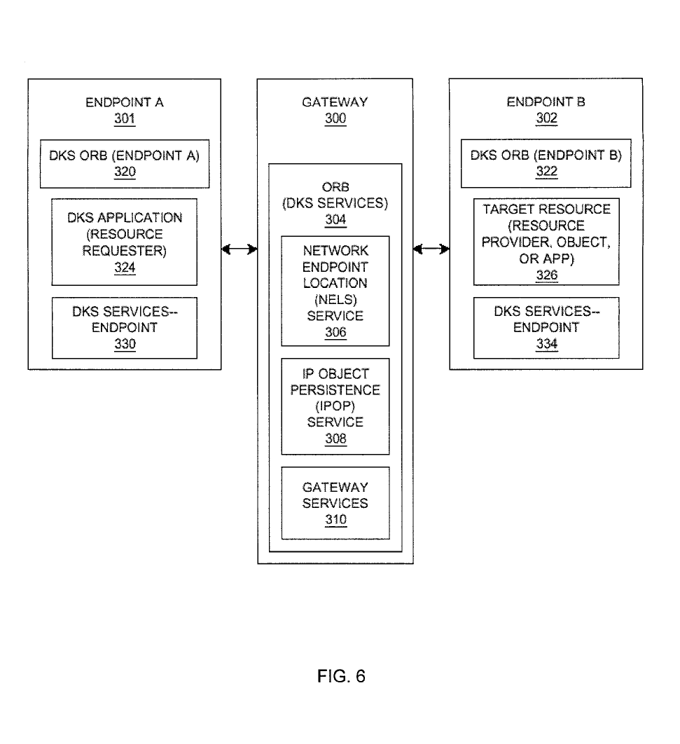

With reference now to FIG. 6, a block diagram depicts components within the system management framework within a distributed computing environment such as that shown in FIGS. 1-5. A network contains gateway 300 and endpoints 301 and 302. Gateway 300 runs ORB 304. In general, an ORB can support different services that are configured and run in conjunction with an ORB. In this case, distributed kernel services (DKS) include Network Endpoint Location Service (NELS) 306, IP Object Persistence (IPOP) service 308, and Gateway Service 310.

The Gateway Service processes action objects, which are explained in more detail below, and directly communicates with endpoints or agents to perform management operations. The gateway receives events from resources and passes the events to interested parties within the distributed system. The NELS works in combination with action objects and determines which gateway to use to reach a particular resource. A gateway is determined by using the discovery service of the appropriate topology driver, and the gateway location may change due to load balancing or failure of primary gateways.

In one embodiment of the invention, the gateway may be used to distribute OS resources using desirable and/or optimal topology.

Other resource level services may include an SNMP (Simple Network Management Protocol) service that provides protocol stacks, polling service, and trap receiver and filtering functions. The SNMP Service can be used directly by certain components and applications when higher performance is required or the location independence provided by the gateways and action objects is not desired. A Metadata Service can also be provided to distribute information concerning the structure of SNMP agents.

The representation of resources within DKS allows for the dynamic management and use of those resources by applications. DKS does not impose any particular representation, but it does provide an object-oriented structure for applications to model resources. The use of object technology allows models to present a unified appearance to management applications and hide the differences among the underlying physical or logical resources. Logical and physical resources can be modeled as separate objects and related to each other using relationship attributes.

By using objects, for example, a system may implement an abstract concept of a router and then use this abstraction within a range of different router hardware. The common portions can be placed into an abstract router class while modeling the important differences in subclasses, including representing a complex system with multiple objects. With an abstracted and encapsulated function, the management applications do not have to handle many details for each managed resource. A router usually has many critical parts, including a routing subsystem, memory buffers, control components, interfaces, and multiple layers of communication protocols. Using multiple objects has the burden of creating multiple object identifiers (OIDs) because each object instance has its own OID. However, a first order object can represent the entire resource and contain references to all of the constituent parts.

Each endpoint may support an object request broker, such as ORBs 320 and 322, for assisting in remote object-oriented operations within the DKS environment. Endpoint 301 contains DKS-enabled application 324 that utilizes object-oriented resources found within the distributed computing environment. Endpoint 302 contains target resource provider object or application 326 that services the requests from DKS-enabled application 324. A set of DKS services 330 and 334 support each particular endpoint.

Applications require some type of insulation from the specifics of the operations of gateways. In the DKS environment, applications create action objects that encapsulate command which are sent to gateways, and the applications wait for the return of the action object. Action objects contain all of the information necessary to run a command on a resource. The application does not need to know the specific protocol that is used to communicate with the resource. The application is unaware of the location of the resource because it issues an action object into the system, and the action object itself locates and moves to the correct gateway. The location independence allows the NELS to balance the load between gateways independently of the applications and also allows the gateways to handle resources or endpoints that move or need to be serviced by another gateway.

The communication between a gateway and an action object is asynchronous, and the action objects provide error handling and recovery. If one gateway goes down or becomes overloaded, another gateway is located for executing the action object, and communication is established again with the application from the new gateway. Once the controlling gateway of the selected endpoint has been identified, the action object will transport itself there for further processing of the command or data contained in the action object. If it is within the same ORB, it is a direct transport. If it is within another ORB, then the transport can be accomplished with a “Moveto” command or as a parameter on a method call.

Queuing the action object on the gateway results in a controlled process for the sending and receiving of data from the IP devices. As a general rule, the queued action objects are executed in the order that they arrive at the gateway. The action object may create child action objects if the collection of endpoints contains more than a single ORB ID or gateway ID. The parent action object is responsible for coordinating the completion status of any of its children. The creation of child action objects is transparent to the calling application. A gateway processes incoming action objects, assigns a priority, and performs additional security challenges to prevent rogue action object attacks. The action object is delivered to the gateway that must convert the information in the action object to a form suitable for the agent. The gateway manages multiple concurrent action objects targeted at one or more agents, returning the results of the operation to the calling managed object as appropriate.

In the preferred embodiment, potentially leasable target resources are Internet protocol (IP) commands, e.g. pings, and Simple Network Management Protocol (SNMP) commands that can be executed against endpoints in a managed region. Referring again to FIG. 5, each NIC at a gateway or an endpoint may be used to address an action object. Each NIC is represented as an object within the IPOP database, which is described in more detail further below.

The Action Object IP (AOIP) Class is a subclass of the Action Object Class. AOIP objects are the primary vehicle that establishes a connection between an application and a designated IP endpoint using a gateway or stand-alone service. In addition, the Action Object SNMP (AOSnmp) Class is also a subclass of the Action Object Class. AOSnmp objects are the primary vehicle that establishes a connection between an application and a designated SNMP endpoint via a gateway or the Gateway Service. However, the present invention is primarily concerned with IP endpoints.

The AOIP class should include the following: a constructor to initialize itself; an interface to the NELS; a mechanism by which the action object can use the ORB to transport itself to the selected gateway; a mechanism by which to communicate with the SNMP stack in a stand-alone mode; a security check verification of access rights to endpoints; a container for either data or commands to be executed at the gateway; a mechanism by which to pass commands or classes to the appropriate gateway or endpoint for completion; and public methods to facilitate the communication between objects.

The instantiation of an AOIP object creates a logical circuit between an application and the targeted gateway or endpoint. This circuit is persistent until command completion through normal operation or until an exception is thrown. When created, the AOIP object instantiates itself as an object and initializes any internal variables required. An action object IP may be capable of running a command from inception or waiting for a future command. A program that creates an AOIP object must supply the following elements: address of endpoints; function to be performed on the endpoint, class, or object; and data arguments specific to the command to be run. A small part of the action object must contain the return end path for the object. This may identify how to communicate with the action object in case of a breakdown in normal network communications. An action object can contain either a class or object containing program information or data to be delivered eventually to an endpoint or a set of commands to be performed at the appropriate gateway. Action objects IP return back a result for each address endpoint targeted.

Using commands such as “Ping”, “Trace Route”, “Wake-On LAN”, and “Discovery”, the AOIP object performs the following services: facilitates the accumulation of metrics for the user connections; assists in the description of the topology of a connection; performs Wake-On LAN tasks using helper functions; and discovers active agents in the network environment.

The NELS service finds a route (data path) to communicate between the application and the appropriate endpoint. The NELS service converts input to protocol, network address, and gateway location for use by action objects. The NELS service is a thin service that supplies information discovered by the IPOP service. The primary roles of the NELS service are as follows: support the requests of applications for routes; maintain the gateway and endpoint caches that keep the route information; ensure the security of the requests; and perform the requests as efficiently as possible to enhance performance.

For example, an application requires a target endpoint (target resource) to be located. In one embodiment of the invention, this may be an endpoint to which an OS may be distributed. The target is ultimately known within the DKS space using traditional network values, i.e. a specific network address and a specific protocol identifier. An action object is generated on behalf of an application to resolve the network location of an endpoint. The action object asks the NELS service to resolve the network address and define the route to the endpoint in that network.

One of the following is passed to the action object to specify a destination endpoint: an EndpointAddress object; a fully decoded NetworkAddress object; and a string representing the IP address of the IP endpoint. In combination with the action objects, the NELS service determines which gateway to use to reach a particular resource. The appropriate gateway is determined using the discovery service of the appropriate topology driver and may change due to load balancing or failure of primary gateways. An “EndpointAddress” object must consist of a collection of at least one or more unique managed resource IDs. A managed resource ID decouples the protocol selection process from the application and allows the NELS service to have the flexibility to decide the best protocol to reach an endpoint. On return from the NELS service, an “AddressEndpoint” object is returned, which contains enough information to target the best place to communicate with the selected IP endpoints. It should be noted that the address may include protocol-dependent addresses as well as protocol-independent addresses, such as the virtual private network ID and the IPOP Object ID. These additional addresses handle the case where duplicate addresses exist in the managed region.

When an action needs to be taken on a set of endpoints, the NELS service determines which endpoints are managed by which gateways. When the appropriate gateway is identified, a single copy of the action object is distributed to each identified gateway. The results from the endpoints are asynchronously merged back to the caller application through the appropriate gateways. Performing the actions asynchronously allows for tracking all results whether the endpoints are connected or disconnected. If the action object IP fails to execute an action object on the target gateway, NELS is consulted to identify an alternative path for the command. If an alternate path is found, the action object IP is transported to that gateway and executed. It may be assumed that the entire set of commands within one action object IP must fail before this recovery procedure is invoked.

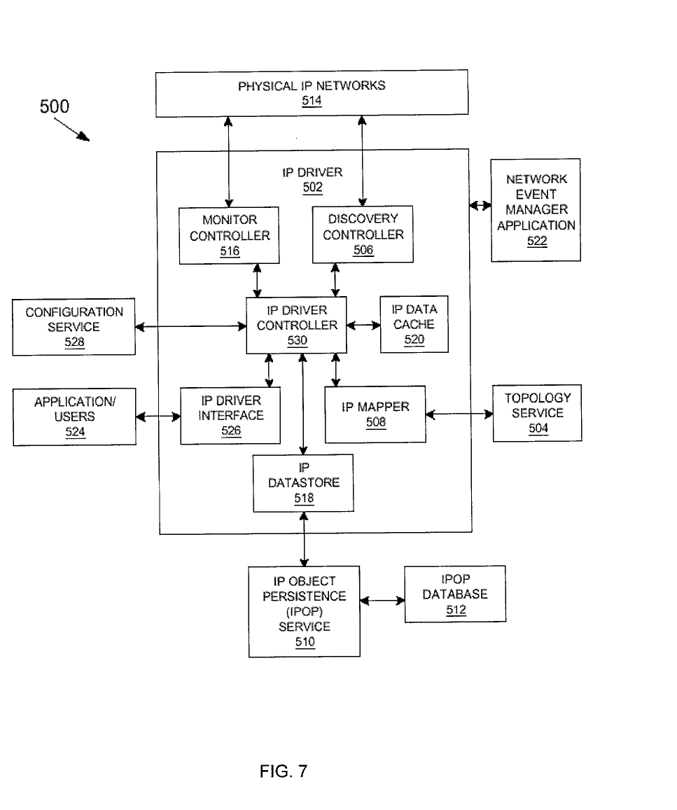

With reference now to FIG. 7, a block diagram shows the IPOP service in more detail. In the preferred embodiment of the present invention, an IP driver subsystem is implemented as a collection of software components for discovering, i.e. detecting, IP “objects”, i.e. IP networks, IP systems, and IP endpoints by using physical network connections. This discovered physical network is used to create topology data that is then provided through other services via topology maps accessible through a graphical user interface (GUI) or for the manipulation of other applications. The IP driver system can also monitor objects for changes in IP topology and update databases with the new topology information. The IPOP service provides services for other applications to access the IP object database.

IP driver subsystem 500 contains a conglomeration of components, including one or more IP drivers 502. Every IP driver manages its own “scope”, which is described in more detail further below, and every IP driver is assigned to a topology manager within Topology Service 504, which may serve more than one IP driver. Topology Service 504 stores topology information obtained from discovery controller 506. The information stored within the Topology Service may include graphs, arcs, and the relationships between nodes determined by IP mapper 508. Users can be provided with a GUI to navigate the topology, which can be stored within a database within the Topology Service.

IPOP service 510 provides a persistent repository 512 for discovered IP objects; persistent repository 512 contains attributes of IP objects without presentation information. Discovery controller 506 detects IP objects in Physical IP networks 514, and monitor controller 516 monitors IP objects. A persistent repository, such as IPOP database 512, is updated to contain information about the discovered and monitored IP objects. IP driver may use temporary IP data store component 518 and IP data cache component 520 as necessary for caching IP objects or storing IP objects in persistent repository 512, respectively. As discovery controller 506 and monitor controller 516 perform detection and monitoring functions, events can be written to network event manager application 522 to alert network administrators of certain occurrences within the network, such as the discovery of duplicate IP addresses or invalid network masks.

External applications/users 524 can be other users, such as network administrators at management consoles, or applications that use IP driver GUI interface 526 to configure IP driver 502, manage/unmanage IP objects, and manipulate objects in persistent repository 512. Configuration service 528 provides configuration information to IP driver 502. IP driver controller 530 serves as central control of all other IP driver components.

Referring back to FIG. 5, a network discovery engine is a distributed collection of IP drivers that are used to ensure that operations on IP objects by gateways 270, and 280 can scale to a large installation and provide fault-tolerant operation with dynamic start/stop or reconfiguration of each IP driver. The IPOP Service manages discovered IP objects; to do so, the IPOP Service uses a distributed database in order to efficiently service query requests by a gateway to determine routing, identity, or a variety of details about an endpoint. The IPOP Service also services queries by the Topology Service in order to display a physical network or map them to a logical network, which is a subset of a physical network that is defined programmatically or by an administrator. IPOP fault tolerance is also achieved by distribution of IPOP data and the IPOP Service among many Endpoint ORBs.

One or more IP drivers can be deployed to provide distribution of IP discovery and promote scalability of IP driver subsystem services in large networks where a single IP driver subsystem is not sufficient to discover and monitor all IP objects. Each IP discovery driver performs discovery and monitoring on a collection of IP resources within the driver's “scope”. A driver's scope, which is explained in more detail below, is simply the set of IP subnets for which the driver is responsible for discovering and monitoring. Network administrators generally partition their networks into as many scopes as needed to provide distributed discovery and satisfactory performance. For example, in some embodiments of the invention, a scope may be provided for each possible pre-boot protocol and/or each OS available for distribution within framework 210, e.g., PXEScope, BlNLScope, DHCPScope, TFTPScope.

A potential risk exists if the scope of one driver overlaps the scope of another, i.e., if two drivers attempt to discover/monitor the same device. Accurately defining unique and independent scopes may require the development of a scope configuration tool to verify the uniqueness of scope definitions. Routers also pose a potential problem in that while the networks serviced by the routers will be in different scopes, a convention needs to be established to specify to which network the router “belongs”, thereby limiting the router itself to the scope of a single driver.

Some ISPs may have to manage private networks whose addresses may not be unique across the installation, like 10.0.0.0 network. In order to manage private networks properly, first, the IP driver has to be installed inside the internal networks in order to be able to discover and manage the networks. Second, since the discovered IP addresses may not be unique in across an entire installation that consists of multiple regions, multiple customers, etc., a private network ID has to be assigned to the private network addresses. In the preferred embodiment, the unique name of a subnet becomes “privateNetworkldsubnetAddress”. Those customers that do not have duplicate networks address can just ignore the private network ID; the default private network ID is 0.

If Network Address Translator (NAT) is installed to translate the internal IP addresses to Internet IP addresses, users can install the IP drivers outside of NAT and manage the IP addresses inside the NAT. In this case, an IP driver will see only the translated IP addresses and discover only the IP addresses translated. If not all IP addresses inside the NAT are translated, an IP driver will not able to discover all of them. However, if IP drivers are installed this way, users do not have to configure the private network ID.

Scope configuration is important to the proper operation of the IP drivers because IP drivers assume that there are no overlaps in the drivers' scopes. Since there should be no overlaps, every IP driver has complete control over the objects within its scope. A particular IP driver does not need to know anything about the other IP drivers because there is no synchronization of information between IP drivers. The Configuration Service provides the services to allow the DKS components to store and retrieve configuration information for a variety of other services from anywhere in the networks. In particular, the scope configuration will be stored in the Configuration Services so that IP drivers and other applications can access the information.

The ranges of addresses that a driver will discover and monitor are determined by associating a subnet address with a subnet mask and associating the resulting range of addresses with a subnet priority. An IP driver is a collection of such ranges of addresses, and the subnet priority is used to help decide the system address. A system can belong to two or more subnets, such as is commonly seen with a Gateway. The system address is the address of one of the NICs that is used to make SNMP queries. A user interface can be provided, such as an administrator console, to write scope information into the Configuration Service. System administrators do not need to provide this information at all, however, as the IP drivers can use default values.

An IP driver gets its scope configuration information from the Configuration Service, which may be stored using the following format:

scopeID=driverID,anchorname,subnetAddress:subnetMask[:privateNetworkid:privateNetworkName:subnetPriority][, subnetAddress:subnetMask:privateNetworkid:privateNetworkName:subnetPriority]]

Typically, one IP driver manages only one scope. Hence, the “scopeID” and “driverID” would be the same. However, the configuration can provide for more than one scope managed by the same driver. “Anchorname” is the name in the name space in which the Topology Service will put the IP networks objects.

A scope does not have to include an actual subnet configured in the network. Instead, users/administrators can group subnets into a single, logical scope by applying a bigger subnet mask to the network address. For example, if a system has subnet “147.0.0.0” with mask of “255.255.0.0” and subnet “147.1.0.0” with a subnet mask of “255.255.0.0”, the subnets can be grouped into a single scope by applying a mask of “255.254.0.0”. Assume that the following table is the scope of IP Driver 2. The scope configuration for IP Driver 2 from the Configuration Service would be:

2=2,ip,147.0.0.0:255.254.0.0,146.100.0.0:255.255.0.0, 69.0.0.0:255.0.0.0.

| Subnet address | Subnet mask |
|---|---|
| 147.0.0.0 | 255.255.0.0 |
| 147.1.0.0 | 255.255.0.0 |
| 146.100.0.0 | 255.255.0.0 |
| 69.0.0.0 | 255.0.0.0 |

In general, an IP system is associated with a single IP address, and the “scoping” process is a straightforward association of a driver's ID with the system's IP address.

Routers and multi-homed systems, however, complicate the discovery and monitoring process because these devices may contain interfaces that are associated with different subnets. If all subnets of routers and multi-homed systems are in the scope of the same driver, the IP driver will manage the whole system. However, if the subnets of routers and multi-homed systems are across the scopes of different drivers, a convention is needed to determine a dominant interface: the IP driver that manages the dominant interface will manage the router object so that the router is not being detected and monitored by multiple drivers; each interface is still managed by the IP driver determined by its scope; the IP address of the dominant interface will be assigned as the system address of the router or multi-homed system; and the smallest (lowest) IP address of any interface on the router will determine which driver includes the router object within its scope.

Users can customize the configuration by using the subnet priority in the scope configuration. The subnet priority will be used to determinate the dominant interface before using the lowest IP address. If the subnet priorities are the same, the lowest IP address is then used. Since the default subnet priority would be “0”, then the lowest IP address would be used by default.

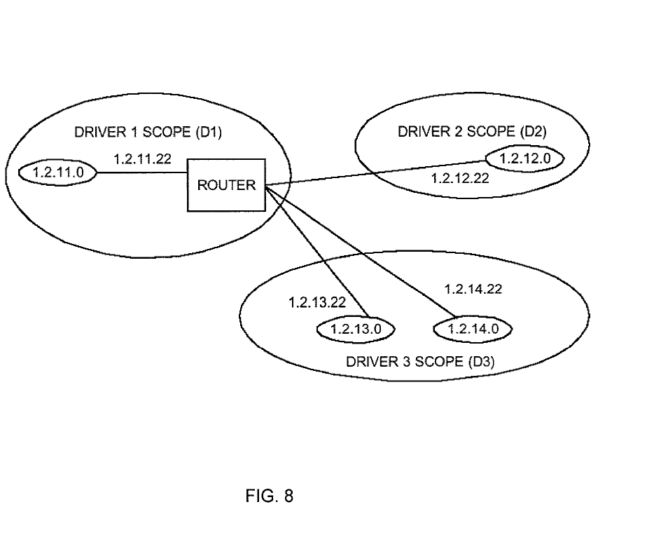

With reference now to FIG. 8, a network diagram depicts a network with a router that undergoes a scoping process. IP driver D1 will include the router in its scope because the subnet associated with that router interface is lower than the other three subnet addresses. However, each driver will still manage those interfaces inside the router in its scope. Drivers D2 and D3 will monitor the devices within their respective subnets, but only driver D1 will store information about the router itself in the IPOP database and the Topology Service database.

If driver D1's entire subnet is removed from the router, driver D2 will become the new “owner” of the router object because the subnet address associated with driver D2 is now the lowest address on the router. Because there is no synchronization of information between the drivers, the drivers will self-correct over time as they periodically rediscover their resources. When the old driver discovers that it no longer owns the router, it deletes the router's information from the databases. When the new driver discovers the router's lowest subnet address is now within its scope, the new driver takes ownership of the router and updates the various data bases with the router's information. If the new driver discovers the change before the old driver has deleted the object, then the router object may be briefly represented twice until the old owner deletes the original representation.

There are two kinds of associations between IP objects. One is “IP endpoint in IP system” and the other is “IP endpoint in IP network”. The implementation of associations relies on the fact that an IP endpoint has the object IDs (OIDs) of the IP system and the IP network in which it is located. Based on the scopes, an IP driver can partition all IP networks, IP Systems, and IP endpoints into different scopes. A network and all its IP endpoints will always be assigned in the same scope. However, a router may be assigned to an IP Driver, but some of its interfaces are assigned to different to different IP drivers. The IP drivers that do not manage the router but manage some of its interfaces will have to create interfaces but not the router object. Since those IP drivers do not have a router object ID to assign to its managed interfaces, they will assign a unique system name instead of object ID in the IP endpoint object to provide a link to the system object in a different driver.

Because of the inter-scope association, when the IP Persistence Service (IPOP) is queried to find all the IP endpoints in system, it will have to search not only IP endpoints with the system ID but also IP endpoints with its system name. If a distributed IP Persistence Service is implemented, the IP Persistence Service has to provide extra information for searching among IP Persistence Services.

An IP driver may use a Security Service to check the availability of the IP objects. In order to handle large number of objects, the Security Service requires the users to provide a naming hierarchy as the grouping mechanism. An IP driver has to allow users to provide security down to the object level and to achieve high performance. In order to achieve this goal, the concepts of “anchor” and “unique object name” are introduced. An anchor is a name in the naming space which can be used to plug in IP networks. Users can define, under the anchor, scopes that belong to the same customer or to a region. The anchor is then used by the Security Service to check if an user has access to the resource under the anchor. If users want the security group define inside a network, the unique object name is used. A unique object name is in the format of:

IP network—privateNetworkID/binaryNetworkAddress

IP system—privateNetworkID/binaryIPAddress/system

IP endpoint—privateNetworkID/binaryNetworkAddress/endppoint

For example:

A network “146.84.28.0:255.255.255.0” in privateNetworkID 12 has unique name:

12/1/0/0/1/0/0/1/0/0/1/0/1/0/1/1/0/1/0/1/0/1/0/1/0/1/1/1/0/0.

A system “146.84.28.22” in privateNetworkID 12 has unique name:

12/1/0/0/1/1/0/0/1/0/1/1/1/1/1/1/0/0/0/0/0/1/1/1/0/0/0/0/0/1/0/1/1/0/system.

An endpoint “146.84.28.22” in privateNetworkId 12 has unique name:

12/1/0/0/1/0/0/1/1/0/0/1/0/1/0/1/0/0/0/0/0/1/1/1/0/0/0/0/0/1/0/1/1/0/endpoint.

By using an IP-address, binary-tree, naming space, one can group all the IP addresses under a subnet in the same naming space that need to be checked by the Security Service.

For example, one can set up all IP addresses under subnet “146.84.0.0:255.255.0.0” under the naming space 12/1/0/0/1/0/0/1/0/0/1/0/1/0/1/0/0 and set the access rights based on this node name.

The IP Monitor Controller, shown in FIG. 7, is responsible for monitoring the changes of IP topology and objects; as such, it is a type of polling engine, which is discussed in more detail further below. An IP driver stores the last polling times of an IP system in memory but not in the IPOP database. The last polling time is used to calculate when the next polling time will be. Since the last polling times are not stored in the IPOP database, when an IP Driver initializes, it has no knowledge about when the last polling times occurred. If polling is configured to occur at a specific time, an IP driver will do polling at the next specific polling time; otherwise, an IP driver will spread out the polling in the polling interval.

The IP Monitor Controller uses SNMP polls to determine if there have been any configuration changes in an IP system. It also looks for any IP endpoints added to or deleted from an IP system. The IP Monitor Controller also monitors the statuses of IP endpoints in an IP system. In order to reduce network traffic, an IP driver will use SNMP to get the status of all IP endpoints in an IP system in one query unless an SNMP agent is not running on the IP system. Otherwise, an IP driver will use “Ping” instead of SNMP. An IP driver will use “Ping” to get the status of an IP endpoint if it is the only IP endpoint in the system since the response from “Ping” is quicker than SNMP.

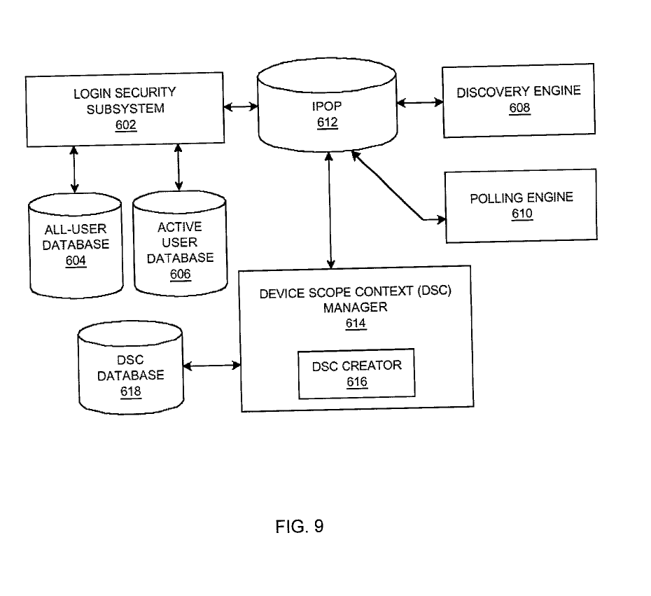

With reference now to FIG. 9, a block diagram shows a set of components that may be used to implement adaptive discovery and adaptive polling in accordance with a preferred embodiment of the present invention. Login security subsystem 602 provides a typical authentication service, which may be used to verify the identity of users during a login process. All-user database 604 provides information about all users in the DKS system, and active user database 606 contains information about users that are currently logged into the DKS system.

Discovery engine 608, similar to discovery controller 506 in FIG. 5, detects IP objects within an IP network. Polling engine 610, similar to monitor controller 516 in FIG. 5, monitors IP objects. A persistent repository, such as IPOP database 612, is updated to contain information about the discovered and monitored IP objects. IPOP also obtains the list of all users from the security subsystem which queries its all-users database 604 when initially creating a DSC. During subsequent operations to map the location of a user to an ORB, the DSC manager will query the active user database 606.

The DSC manager 614 queries IPOP for all endpoint data during the initial creation of DSCs and any additional information needed, such as decoding an ORB address to an endpoint in IPOP and back to a DSC using the IPOPOid, the ID of a network object as opposed to an address.

As explained in more detail further below with respect to FIG. 8, an administrator will fill out the security information with respect to access user or endpoint access and designate which users and endpoints will have a DSC. If not configured by the administrator, the default DSC will be used. While not all endpoints will have an associated DSC, IPOP endpoint data 612, login security subsystem 602, and security information 604 are needed in order to create the initial DSCs.

The DSC manager 614, acting as a DSC data consumer, explained in more detail further below, then listens on this data waiting for new endpoints or users or changes to existing ones. DSC configuration changes are advertised by a responsible network management application. Some configuration changes will trigger the creation of more DSCs, while others will cause DSC data in the DSC database to be merely updated.

All DSCs are stored in DSC database 618 by DSC creator 616, which also fetches DSCs upon configuration changes in order to determine whether or not a DSC already exists. The DSC manager primarily fetches DSCs from DSC database 618, but also adds runtime information, such as ORB ID, which is ultimately used to determine the manner in which the polling engine should adapt to the particular user or endpoint.

As described above, an IP driver subsystem is implemented as a collection of software components for discovering, i.e. detecting, network “objects”, such as IP networks, IP systems, and IP endpoints by using physical network connections. The collected data is then provided through other services via topology maps accessible through a GUI or for the manipulation of other applications. The IP driver system can also monitor objects for changes in IP topology and update databases with the new topology information. The IPOP service provides services for other applications to access the IP object database.

Referring again to FIG. 7, IP driver subsystem 500 contains a conglomeration of components, including one or more IP drivers 502. Every IP driver manages its own “scope”, and every IP driver is assigned to a topology manager within Topology Service 504, which stores topology information obtained from discovery controller 506. The information stored within the Topology Service may include graphs, arcs, and the relationships between nodes determined by IP mapper 508. Users can be provided with a GUI to navigate the topology, which can be stored within a database within the Topology Service.

The topology service provides a framework for DKS-enabled applications to manage topology data. In a manner similar to the IPOP service, the topology service is actually a cluster of topology servers distributed throughout the network. All of the functions of the topology service are replicated in each server. Therefore, a client can attach to any server instance and perform the same tasks and access the same objects. Each topology-related database is accessible from more than one topology server, which enables the topology service to recover from a server crash and provide a way to balance the load on the service.

Topology clients create an instance of a TopoClientService class. As part of creating the TopoClientService instance, the class connects to one of the topology servers. The topology server assumes the burden of consolidating all of the topology information distributed over the different topology servers into a single combined view. The topology service tracks changes in the objects of interest to each client and notifies a client if any of the objects change.

The topology service may have a server-cluster design for maximizing availability. As long as there is at least one instance of the topology server running, then clients have access to topology objects and services. The topology service design allows for servers to occasionally fail. Each server is aware of the state of all the other server instances. If one instance fails, the other servers know immediately and automatically begin to rebuild state information that was lost by the failed server. A client's TopoClientService instance also knows of the failure of the server to which it is connected and re-connects to a different server. The objects residing at a failed topology server are migrated to the other topology servers when the drivers owning those objects have re-located.

The topology service is scalable, which is important so that the service may be the central place for all network topology objects for all of the different DKS-related applications in order to provide efficient service for millions of objects. As the number of clients, drivers, and objects increase, an administrator can create more instances of topology servers, thereby balancing the workload. Using the server cluster approach, any growth in the number of clients, drivers, and objects is accommodated by simply adding more servers. The existing servers detect the additional instances and begin to move clients and drivers over to the new instances. The automated load-balancing is achieved because the clients and objects are not dependent on any one server instance.

In order to provide a service for an entire enterprise, all of the enterprise's objects generally do not reside in the same database. There may be many reasons that make it undesirable to require that all topology objects be stored in the same database instance. For example, a database simply may not be reachable across an international boundary, or the volume of information going into the database may exceed a single database's capacity. Therefore, the topology objects may span databases, and there may be relationships between objects in different databases. However, it may be assumed that all topology objects in a domain reside in the same database. For example, all IP objects for a single enterprise do not necessarily reside in the same database as the enterprise's IP space may be split into many domains, e.g., a southwest IP domain and a northeast IP domain, but each domain may reside in different databases and still have relations between their objects. Hence, it is possible to have two objects related to each other even though they are in different databases. Since the name of the domain is part of the id of the object, each object can be uniquely identified within the entire topology service.

When an applications is installed and configured to use the DKS services, the application provides some information to the topology service about the different types of TopoObjects it will be creating. This class information closely resembles the network entities that a driver will be managing. For example, an IP application works with Network, System, and Endpoint resource types, as described previously with respect to FIG. 4. Giving TopoObjects a resource type enables client applications to identify, group, and query the databases based on domain-specific types. Each resource type may have many different types of relations that the driver may create, and the most common type may be the containment relation, which shows the containment hierarchy of a domain. Each relation type has a corresponding ViewData object, which provides information that an administrative console needs to create a view of the TopoObjects. For example, the ViewData object may contain members like BackgroundColor and LayoutType that are used to construct a graphical display of the object. Relations can be created between any two TopoObjects. The TopoObjects can be owned by the same driver, different drivers in the domain, or even drivers in different domains.

As mentioned previously, with a very large network of more than a million devices, it is difficult to display the network topology. Moreover, while a corporate network or department-level local area network may be relatively stable with a relatively unchanging topology, a very large network may undergo constant change, which elevates the difficulty for a system administrator to understand the dynamic nature of a very large network. The present invention contains an architecture that supports the display of historical views of network actions and network topology, thereby providing graphical snapshots of a dynamic network.

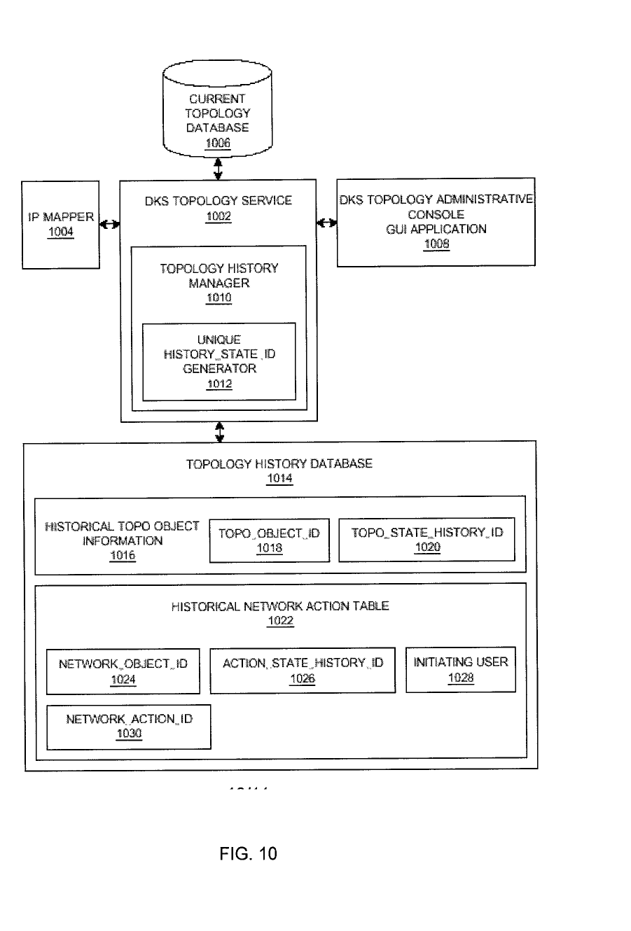

With reference now to FIG. 10, a block diagram depicts an architecture for supporting the display of topology data within a large, distributed network in accordance with one embodiment of the present invention. In a manner similar to that shown in FIG. 7, topology service 1002 receives data for network-related objects from IP mapper 1004; topology service 1002 is able to map data from the IP drivers and the IPOP database into smaller virtual networks upon which specific system administrators can request network actions. As described above, a distributed database holds the topology data for distributed topology servers; topology database 1006 holds topology data for topology service 1002.

DKS topology administrative console GUI application 1008 (hereinafter topology console) displays various views of the topology for current physical networks and virtual networks as requested by administrative users, thereby providing real-time feedback to these users.

Because the display of the objects can morph due to physical network changes and virtual network changes, e.g., as changes in scope of responsibility for various subnets, in addition to data gathered in response to actions on network-related objects, e.g., a ping or an SNMP query, the topology console receives data from the highly distributed DKS topology service. In order for administrative users to understand the manner in which the topology of the network is changing, the topology console displays historical views of topological information, and the topology service supports the accumulation, storage, and management of the topological information. Topology service 1002 includes topology history manager 1010, which contains history-state-ID generator 1012 for generating unique IDs to be associated with historical information, as discussed in more detail further below.

Topology history manager 1010 manages topology history database 1014. Topology objects, i.e. TopoObjects, are saved when changes in topology occur; rather than saving all changes to the entire device network, preferably only those changes that are of interest to an administrative user are saved. Topology history database 1014 has columns or records for storing historical TopoObject information 1016, which includes TopoObjectIDs 1018, TopoStateHistoryIDs 1020, and any other data fields that may be helpful in recreating TopoObjects that existed during a period of interest to an administrative user.

Some of the changes in topology may occur due to network actions or commands that initiated by an administrative user from the topology console. For example, from the topology console, administrative users may want to customize the topology or diagnose problems within a network. An example of an action is a Wake-On-Lan message that is used to power a target system. Historical Network Action table 1022 is used to store information related to user-requested actions. Columns or records that may be used within table 1022 may include: NetworkObjectID 1024 that is associated with the network-related object on which an action was performed; ActionStateHistoryID 1026 that was generated by HistoryStateID generator 1012 and associated with the requested action; user information 1028 that identifies the user who initiated the action; NetworkActionID 1030 that identifies the type of network action requested by the user; and any other information that is useful for tracking network-related actions.

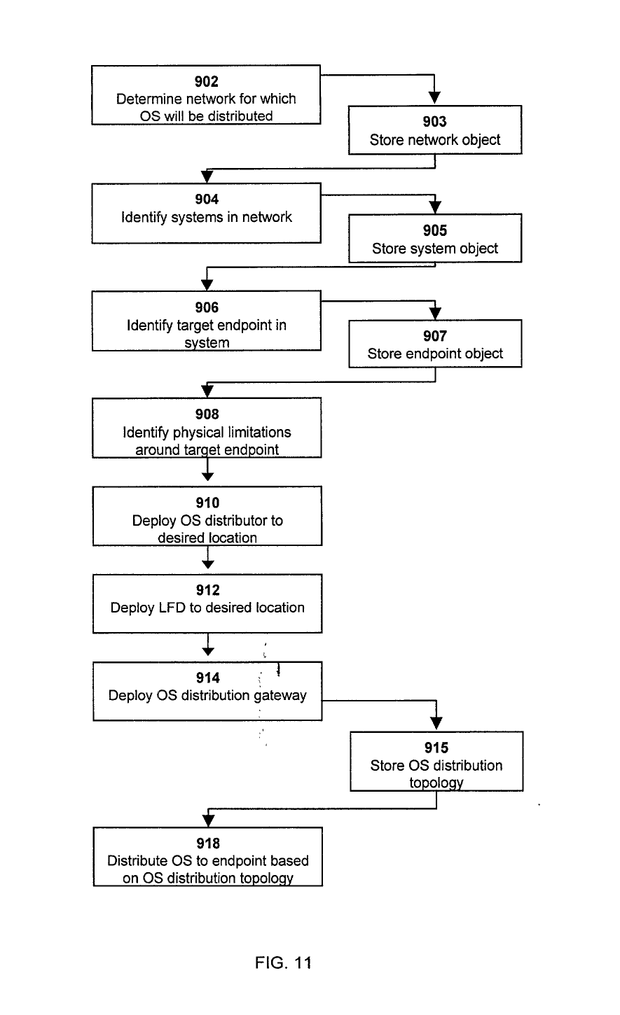

FIG. 11 is a flow diagram of one embodiment of a method of booting a target device in accordance with the present invention. Although the method of FIG. 11 shows the booting of a single target device or endpoint, a plurality of target devices or endpoints may be booted according to the present invention. These devices may be located within the same network or subnet and/or associated with the same gateway of management framework 210. Alternatively, these devices may be located within different networks or subnets and/or associated with different gateways as depicted above.

At block 902, the network within which a given OS may be distributed is determined. This may be determined for example, when one or more discovery engines scan physical networks until a new device is found or until a device requesting an OS is found. In some embodiments of the invention, the steps described at blocks 902, 904, and 906 may be accomplished by a single discovery engine scanning for an endpoint requiring an OS. For example, a determination may be made as to whether or not a network object exists for the network in which the endpoint has been found. If not, then a network object is created, otherwise the process continues. At block 903, the network object may be stored.

As seen at block 904, a determination of the systems within the network may be made. For example, it may be determined whether or not a system object exists for the system in which the endpoint has been found using one or more discovery engines as described above. If a system object does not exist, then a system object may be created, otherwise the process continues. At block 905, the system object may be stored.

As seen at block 906, an endpoint object may then be created for the discovered device. In one embodiment of the invention, all objects created objects are then stored within the IPOP database as seen at block 907. The created objects may then be mapped into the current topology, and the topology service creates topology objects and stores them within the topology database as described above.

As seen at block 908, once an endpoint has been targeted, any suitable component of management framework 210 may be used to evaluate the communications limitations existing around the target endpoint. In particular, the physical limitations that might interfere with or impede the distribution of an OS may be evaluated. For example, slow links between the target endpoint and the OS distribution server (OS distributor) may be located. Other limitations in communication values between the target endpoint and available OS distribution services may be evaluated.

These evaluations will determine the OS distribution topology formulated for the target endpoint in steps 910, 912 and 914. For example, in some embodiments of the invention, if the OS boot time from a given OS distributor to target endpoint is greater than a predetermined amount of time, a different OS distributor may be deployed at block 910. In another embodiment, if the OS boot time from a given OS distributor to target endpoint is less than the predetermined amount of time, that particular OS distributor may be assigned the OS distributor function.

Alternatively, the proximity of an OS distributor, an LFD component or an OS gateway to the target endpoint may be determined at block 908. Thus, in some embodiments of the invention, if a given OS distributor is located at a distance greater than a predetermined OS distributor distance, a different OS distributor may be deployed at block 910. In another embodiment, if the OS distributor is located within a predetermined distance from the target endpoint is less than the predetermined amount of time, that particular OS distributor may be assigned the OS distributor function.

Alternatively, if a given LFD component is located at a distance greater than a predetermined LFD component distance, a different LFD component may be deployed at block 912. In another embodiment, if the LFD component is located within a predetermined distance from the target endpoint, that particular LFD component may be assigned the LFD component function.

Alternatively, if a given OS distribution gateway is located at a distance greater than a predetermined LFD component distance, a different OS distribution gateway may be deployed at block 914. In another embodiment, if the OS distribution gateway is located within a predetermined distance from the target endpoint, that particular gateway may be assigned the gateway function.

In some embodiments of the invention, an OS distributor may serve any one of the distribution functions, e.g. distribution engine, LFD component or distribution gateway, depending on its evaluated communication value. For example, a particular server may provide a distribution engine service to a target endpoint at one distance value from the server. The same server may serve as an LFD component to a second target device at a second distance value from the server. Moreover, the same server may serve as a distribution gateway from a third target device at a third distance value from the server.

In other embodiments of the invention, the scope of the OS distributor may be assigned based on the evaluated communication value between the distributor and the target endpoint. For example, an OS distributor with one value may be assigned the distribution of PXE OS resources. Another OS distributor related to the same target endpoint but having a different communication value may be assigned to the distribution of pre-boot protocols. Other OS distributors with other communication values may be assigned for example to the distribution of BINL OS resources, DHCP OS resources, TFTP OS resources, etc.

As seen at block 910, once the limitations have been evaluated and/or the physical topology of OS resources in relation to the target endpoint have been determined, a suitable OS distributor may be deployed to a desired location. For example, the location may be one which is near the target endpoint. Alternatively, the location may be one in which the link between OS distributor and target endpoint is optimal, e.g., running quickly, not being slowed down, etc. A suitable OS distributor may be, for example, a boot server as described above, an OS distribution engine and a component within system framework 210 which is enabled to distribute an OS to another device.

As seen at block 912, an LFD component as described above may also be deployed to a desired location. For example, the location may be one which is near the target endpoint. Alternatively, the location may be one in which the link between the LFD component and target endpoint is optimal, e.g., running quickly, not being slowed down, etc. A suitable LFD component may be any program capable of distribution large files or images, including, but not limited to boot images.

As seen at block 914, an OS distribution gateway as described above may also be deployed. In some embodiments of the invention, the OS distribution gateway may also be deployed to a desired location. For example, the location may be one which is near the target endpoint. Alternatively, the location may be one in which the link between the OS distribution gateway and target endpoint is optimal, e.g., running quickly, not being slowed down, etc. Alternatively, the OS distribution gateway may be deployed to conduct suitable actions. For example, OS distribution gateway may be deployed to answer and/or send requests, such as pre-boot packet requests, on behalf of the OS distribution engine. Alternatively, OS distribution gateway may be deployed to answer and/or send requests, on behalf of the target endpoint. A suitable OS distribution gateway may be one or more of the gateways described above.

As seen at block 915, the created topology for OS distribution to a given target endpoint may then be stored. This may be accomplished, for example, using the architecture of FIG. 10. The OS distribution topology may describe, for example, the location of the target endpoint in relation to the OS distributor, the LFD component and the OS distribution gateway.

As seen at block 918, an OS may be distributed to the target endpoint based on the OS distribution topology determined above. For example, the OS may be distributed from the OS distributor, supported by the LFD component via the OS distribution gateway to the target endpoint. Distribution of an OS may be accomplished using any suitable protocol. For example, a pre-boot protocol or remote boot protocol as described above may be used. A chained bootstrap protocol may also be used.

As one example, the target endpoint may be able to send and receive requests and responses for OS files, from the OS distributor. These may be, for example configuration files, bootstraps and/or additional files necessary to boot a minimal OS or an entire core operating system for a given endpoint. These files may include, for example, files to load target device drivers and system libraries of the target device. Alternatively, the target endpoint may receive an installation program. These files may be loaded onto the target endpoint. These files may then be executed on the target endpoint. Once an OS has been distributed to the target endpoint, the OS distribution topology for the target endpoint may be stored for OS distribution at a later time. Alternatively, a new OS distribution topology may be dynamically created for the same target endpoint in the event that the target endpoint requires or requests a new OS.

The method of the present invention may be repeated for distribution of one or more operating systems to other target endpoints. Moreover, the method of the present invention may be used for distribution of operating systems to a plurality of target endpoints simultaneously, creating corresponding OS distribution topology for each target endpoint.

In one embodiment of the invention, the method of the present invention may be used to dynamically re-locate the OS distribution engine and/or the LFD component services in relation to the target endpoint depending on the state of the network management framework evaluated at block 908. This

Further information regarding the system management framework and components of the present invention is disclosed co-pending U.S. patent application Ser. No. ______, (Attorney Docket No. AUS920010289US1) to Ullmann, et al., entitled “Method and system for network management with topology system providing historical topological views,” filed ______, herein incorporated by reference in its entirety.

While the present invention has been described in the context of a fully functioning data processing system, it will be appreciated that the processes described may be distributed in any other suitable context. For example, the processes described may take the form of a computer readable medium of instructions. The present invention applies equally regardless of the type of signal-bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms such as, for example, radio frequency and light wave transmissions. The computer readable media may take the form of coded formats that are decoded for actual use in a particular data processing system.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

1. A method of booting one of a plurality of target devices in a network management framework, comprising:
scanning the network management framework to identify the target device;
determining a communication value, the communication value describing communication between the target device and at least one distributor;
comparing the communication value to a predetermined value;
assigning the distributor to the target device if the communication value is less than the predetermined value; and
distributing at least one boot file to the target device using the distributor.

2. The method of claim 1 wherein the communication value comprises a distance value of a distance between the target device and the distributor.

3. The method of claim 1 wherein the communication value comprises a boot time value of a time to transfer files between the target device and the distributor.

4. The method of claim 1 further comprising:
assigning a distributor function to the distributor based on the communication value, wherein the distributor function is selected from the group consisting of:
a distribution engine, a large file distribution component, and a distribution gateway.

5. The method of claim 1 further comprising:
assigning a distributor scope to the distributor based on the communication value, wherein the distributor scope is selected from the group consisting of:
a pre-boot resource, a boot resource, a PXE resource, a BINL resource, a DHCP resource and a TFTP resource.

6. The method of claim 1 wherein the distributor is selected from the group consisting of:
a distribution engine, a large file distribution component, and a distribution gateway.

7. The method of claim 6 further comprising:
sending the boot file from the distribution engine to the target device.

8. The method of claim 6 further comprising:
sending the boot file between the large file distribution component and the target device.

9. The method of claim 6 further comprising:
forwarding the boot file from the distribution gateway to the target device.

10. The method of claim 6, further comprising:
receiving the boot file from the distribution engine at the distribution gateway.

11. The method of claim 1 further comprising:
requesting, at the target device, the boot file.

12. The method of claim 1 wherein the boot file is selected from the group consisting of:
a pre-boot packet request, a bootstrap program, a configuration file, a boot parameters file, and an operating system file.

13. The method of claim 13, further comprising:
creating a distribution topology, wherein the distribution topology describes at least one distributor location and a target device location.

14. The method of claim 13, further comprising:
distributing the boot file to the target device from the distributor using the distribution topology.

15. The method of claim 11, further comprising:
storing the distribution topology.

16. Computer program product in a computer usable medium for booting one of a plurality of target devices in a network management framework, comprising:
means for scanning the network management framework to identify at least one target device;
means for determining a communication value, the communication value describing communication between the target device and at least one distributor;
means for comparing the communication value to a predetermined value;
means for assigning the distributor to the target device if the communication value is less than the predetermined value; and
means for distributing at least one boot file to the target device using the distributor.

17. The program of claim 16, further comprising:
means for determining the communication value from a distance between the target device and the distributor.

18. The program of claim 16, further comprising:
means for measuring a boot time to transfer files between the target device and the distributor to determine the communication value.

19. The program of claim 16, further comprising:
means for assigning a distributor function to the distributor based on the communication value, wherein the distributor function is selected from the group consisting of:
a distribution engine, a large file distribution component, and a distribution gateway.

20. The program of claim 16 further comprising:
means for assigning a distributor scope to the distributor based on the communication value, wherein the scope is selected from the group consisting of:
a pre-boot resource, a boot resource, a PXE resource, a BINL resource, a DHCP resource and a TFTP resource.

21. The program of claim 16 wherein the distributor is selected from the group consisting of:
a distribution engine, a large file distribution component, and a distribution gateway.

22. The program of claim 21, further comprising:
means for sending the boot file from the distribution engine to the target device.

23. The program of claim 21, further comprising:
means for sending the boot file between the large file distribution component and the target device.

24. The program of claim 21, further comprising:
means for forwarding the boot file from the distribution gateway to the target device.

25. The program of claim 21, further comprising:
means for receiving the boot file from the distribution engine at the distribution gateway.

26. The program of claim 16, further comprising:
means for requesting, at the target device, the boot file.

27. The program of claim 16 wherein the boot file is selected from the group consisting of:
a pre-boot packet request, a bootstrap program, a configuration file, a boot parameters file, and an operating system file.

28. The program of claim 16 further comprising:
means for creating a distribution topology, wherein the distribution topology describes at least one distributor location and a target device location.

29. The program of claim 28, further comprising:
means for distributing the boot file to the target device from the distributor using the distribution topology.

30. The program of claim 28, further comprising:
means for storing the distribution topology.

31. A system for booting one of a plurality of target devices in a network management framework, comprising:
means for scanning the network management framework to identify at least one target device;
means for determining a communication value, the communication value describing communication between the target device and at least one distributor;
means for comparing the communication value to a predetermined value;
means for assigning the distributor to the target device if the communication value is less than the predetermined value; and
means for distributing at least one boot file to the target device using the distributor.

32. The system of claim 31, further comprising:
means for determining the communication value from a distance between the target device and the distributor.

33. The system of claim 31, further comprising:
means for measuring a boot time to transfer files between the target device and the distributor to determine the communication value.

34. The system of claim 31, further comprising:
means for assigning a distributor function to the distributor based on the communication value, wherein the distributor function is selected from the group consisting of:
a distribution engine, a large file distribution component, and a distribution gateway.

35. The system of claim 31 further comprising:
means for assigning a distributor scope to the distributor based on the communication value, wherein the scope is selected from the group consisting of:
a pre-boot resource, a boot resource, a PXE resource, a BINL resource, a DHCP resource and a TFTP resource.

36. The system of claim 31 wherein the distributor is selected from the group consisting of:
a distribution engine, a large file distribution component, and a distribution gateway.

37. The system of claim 36, further comprising:
means for sending the boot file from the distribution engine to the target device.

38. The system of claim 36, further comprising:
means for sending the boot file between the large file distribution component and the target device.

39. The system of claim 36, further comprising:
means for forwarding the boot file from the distribution gateway to the target device.

40. The system of claim 36, further comprising:
means for receiving the boot file from the distribution engine at the distribution gateway.

41. The system of claim 31, further comprising:
means for requesting, at the target device, the boot file.

42. The system of claim 31 wherein the boot file is selected from the group consisting of:
a pre-boot packet request, a bootstrap program, a configuration file, a boot parameters file, and an operating system file.

43. The system of claim 31 further comprising:
means for creating a distribution topology, wherein the distribution topology describes at least one distributor location and a target device location.

44. The system of claim 43, further comprising:
means for distributing the boot file to the target device from the distributor using the distribution topology.

45. The system of claim 43, further comprising:
means for storing the distribution topology.
